(19) United States
(12) Patent Application Publication
(10) Pub. No.: US 2014/0317058 A1
(43) Pub. Date: Oct. 23, 2014

(54) WIRELESS STORAGE DEVICE AND SYSTEM HAVING CAPABILITY OF AUTONOMOUS BACKUP

(71) Applicant: CARRY TECHNOLOGY CO., LTD., New Taipei City (TW)

(72) Inventors: TA-RON CHANG, NEW TAIPEI CITY (TW); LIN TIEN, TAIPEI CITY (TW); YING-CHING LEE, NEW TAIPEI CITY (TW)

(73) Assignee: CARRY TECHNOLOGY CO., LTD., New Taipei City (TW)

(21) Appl. No.: 14/016,278

(22) Filed: Sep. 3, 2013

(30) Foreign Application Priority Data
Apr. 19, 2013 (TW) 102207195

(51) Int. Cl. G06F 11/14

(52) U.S. Cl. CPC G06F 11/1448
USPC 707/640

(57) ABSTRACT

Disclosure is to a wireless storage device capable of performing an autonomous backup. The device adopts a wireless communication technology to render a variety of access services for a wireless terminal device. For example, the storage device provides an external backup service to the connected terminal device. The device performs data packets routing for the terminal device to a network. The storage device is able to process video signals from the terminal device and broadcast video onto a display. In one embodiment, in addition to the built-in storage medium, various interfaces are disposed onto the wireless storage device to connect with many types of external storage devices. When the wireless terminal device issues a backup instruction, the wireless storage device performs backup between the medium. In particular, the backup procedure is autonomously operated in the device without occupying bandwidth between the devices as transferring the data.

### BACKGROUND

1. Technical Field

The present invention is generally related to a wireless storage device; in particular, it is to the wireless storage device with capability of autonomous backup among the external or built-in storage devices, so as to conduct external backup or file sharing for a wireless terminal device.

2. Description of Related Art

The modern portable devices such as smart mobile phone and tablet computer are now in widespread use for everybody as a general purpose device. A need for sharing data with each other or data storage and backup among devices is also generated. In general, the technology for operating data transmission between two devices is restricted by the compatibility of communication protocols there-between. Further, the transmitting rate may also be restricted to the method for conducting the transmission and its bandwidth. The communication protocol made between the two ends is such as WiFi™, Bluetooth™, or NFC (Near-Field Communication).

For example, regarding data exchanging over the WiFi™ communication, the WiFi™ communication technology is generally based on a client-server relationship. The transmission between a client and a server may be done when the server end is firstly defined with the other end is as a client. The further transmission method may be based on a specific transmission program installed at the both ends. Still further, a peer-to-peer transmission technology such as under an Ad-Hoc mode may be made to conduct the transmission.

The mentioned peer-to-peer transmission method may be implemented by Bluetooth™ communication technology. The Bluetooth™ communication protocol is used to exchange data under a limited bandwidth after a beforehand paring process. The Near-Field communication may also be one solution to implement the data exchange even though the two devices are required to be within a short distance for handshaking process and the data transmission is also much restricted.

Besides the above-mentioned technologies for data transmission, one further way to transmit files between two devices is to set up a medium device. The medium device is such as a cloud server, an external hard disk, a flash drive, or a computer host that firstly retrieves the files and then shares them to the target device.

Further, this medium device may be configured to have two or more storage devices. For example, one of the storage devices is a built-in storage medium such as hard disk or flash memory; the other one is such as an expandable storage medium such as the external hard disk or memory card. A mobile device may need to control the data exchanging process between the different storage medium as they are required to transmit data for each other. FIG. 1 shows the flow depicting the process of data exchange.

FIG. 1 shows a schematic diagram describing an external device 1 configures a storage device 10 to exchange data. The modules built in the storage device 10 include a storage unit 105 and a storage interfacing unit 107 for accepting a memory card 109. The shown external device 1 may firstly establish connection with the storage device 10 via a communication protocol. The storage device 10 includes a controller 101 to process a control signal received from external via a communication unit 103.

The control signal may be configured by a specific software program executed in the external device 1, and used to control the backup process in the storage device 10. For example, a memory card 109 may be plugged to the storage device 10 via the storage interfacing unit 107. Therefore the data in the memory card 109 may be backup to the storage device 10 via this storage interfacing unit 107. The storage unit 105 may handle this backup process with respect to its built-in hard disk or the types of memories. The backup process allows the data in the memory card 109 to be buffered in a memory of the external device 1, and then transmitted to the storage unit 105. However, the process of data transmission occupies most of the bandwidth between the two devices (1, 10).

### SUMMARY

In order to provide a scheme of external storage and data backup for a portable device, and simultaneously processing data exchange among two or more devices, provided to the present invention is a wireless storage device capable of autonomous backup. This wireless storage device may also convey packets routing and playback of audio/video. In particular, through a wireless communication technology built in the storage device, the device may provide various services for the portable device.

In an exemplary aspect of the invention, the wireless storage device with capability of autonomous backup includes at least two different types of storage medium having a first storage medium and a second storage medium. The device includes a communication unit used to connect with a wireless terminal device. The device further includes a processing unit used to process a control signal for performing autonomous backup between the first storage medium and the second storage medium.

For example, the first storage medium may be the storage built in the wireless storage device; the second storage medium may be an external storage device connected with the wireless storage device via a storage interfacing unit. The external storage device is such as an external hard disk, flash drive, or a memory card. For operating the autonomous backup, the processing unit may require a buffer memory prepared for the backup process.

For the wireless terminal device operating the autonomous backup, a button or other type of activation interface may be mounted on the wireless storage device for launching the autonomous backup process.

The wireless storage device may be a multifunctional portable routing device, in which the routing process may be performed by a packet processing unit. The power source in the storage device may also be supplied to the wireless terminal device. The wireless storage device further includes an audio processing unit which is used to process audio generated by the wireless terminal device; a video processing unit is used to process the video signals and display the video onto a display via a video interfacing unit.

In one further aspect, a storage system including the wireless storage device and the wireless terminal device is provided.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram depicting an external device accessing a storage device in a conventional technology;

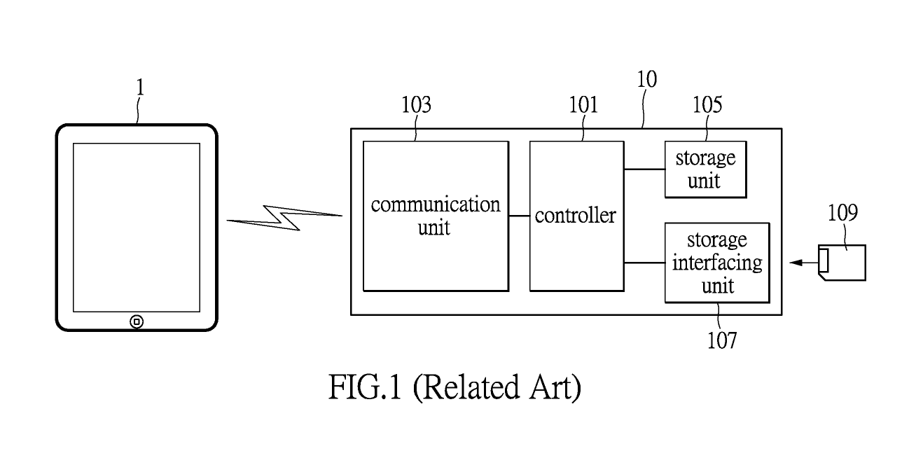

FIG. 2 shows a schematic diagram depicting relationship between a wireless storage device with capability of autonomous backup and every device;

FIG. 3 schematically illustrates connection between the wireless storage device and a wireless terminal device in one embodiment of the present invention;

FIG. 4 shows a schematic diagram of the wireless storage device in one embodiment of the present invention;

FIG. 5 shows circuit blocks depicting the wireless storage device with capability of autonomous backup in one embodiment of the present invention;

FIG. 6 shows a schematic diagram illustrating the wireless storage device externally playing audio and video in one embodiment of the present invention;

FIG. 7 shows a schematic diagram depicting the wireless storage device performing packet routing in one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

A wireless storage device with capability of autonomous backup is disclosed. The wireless storage device may be a standalone storage device. When a communication circuit in the storage device is used to conduct a wireless communication protocol, the other portable device is allowed to wirelessly access the storage medium of the storage device. For example, the mentioned portable device may thereby access the storage device built in or externally to the wireless storage device.

This wireless storage device is able to perform backup autonomously among the different storage medium. The claimed scheme in accordance with the present invention allows the portable device to conduct an external backup or file sharing. While the autonomous backup process is in operation, the process may not occupy the transmission bandwidth for the external device's access. The wireless storage device is configured to have a connection port used to connect with the external device. Through this connection port, the wireless storage device may electrically power the portable device, or charge the battery in the device in addition to processing packets routing.

The wireless storage device is provided to perform an autonomous backup process. In an exemplary embodiment, the wireless storage device autonomously performs backup process among the medium since the external device issues an instruction for backup. In one further embodiment, a button or other type of activation interface may be introduced to the wireless storage device for a user to trigger the backup process. The button is electrically connected with the communication circuit and storage medium. For example, once the user pushes the button, the autonomous backup process is initiated. The backup process is applied to performing backup for a memory card plugged to the wireless storage device and an external storage device connected to the wireless storage device via USB. The backup process may also be configured to perform bidirectional data synchronization with a connected portable device.

Regarding the triggering signal for the backup process, the external device may generate the backup instruction. Alternatively, the button or any other activation interface installed on the wireless storage device may be used to activate the wireless backup process. For example, the wireless storage device may automatically be configured to establish a connection with the wireless terminal device while the user triggers the backup process by the button. It is noted that the terminal device should firstly complete the connection figuration at the earlier stage when the connection is established over a wireless communication protocol. The wireless terminal device is such as a mobile phone, tablet computer, or other types of portable devices.

In one further embodiment, the wireless storage device may also conduct audio/video conversion. In an exemplary example, the wireless storage device may play audio signals sent from the portable device via a speaker. Further, the wireless storage device conducts the signal conversion and in the meantime plays the video to a display over a video interface.

The wireless storage device, according to one of the embodiments, is such as a device integrated with a wireless network circuit, independent power supply, built-in card reader, and/or an interface for connecting with external storage. The wireless storage device appears, but not limited to, to be based on a design of a network router, gateway, switch, or any device with specific purpose. For example, if the wireless storage device is a wireless network router having built-in or connected external storage medium, it is featured that the any portable device without any connection port may be allowed to wirelessly access the storage medium of the device. The storage medium is such as a memory card, an external hard disk, or an external optical drive.

For establishment of connection, the wireless storage device should recognize the every connected external device. The network identification for the device connected with the network is based on an address of Media Access Control (MAC), Internet Protocol (IP) address, device's name, or other recognizable ID. The device at least includes a memory card access interface such as a card reader that supports features of power-saving and hot swapping. The device also includes one further access interface for linking the external storage device. The access interface may be a universal serial bus (USB), a peripheral component interconnect (PCI or PCI Express) interface, Firewire, or Thunderbolt. Further, the wireless storage device may include an independent power supply that takes direct current (DC) or/and alternate current (AC) source. Through a specific communication protocol, the wireless storage device is accessible to the external device.

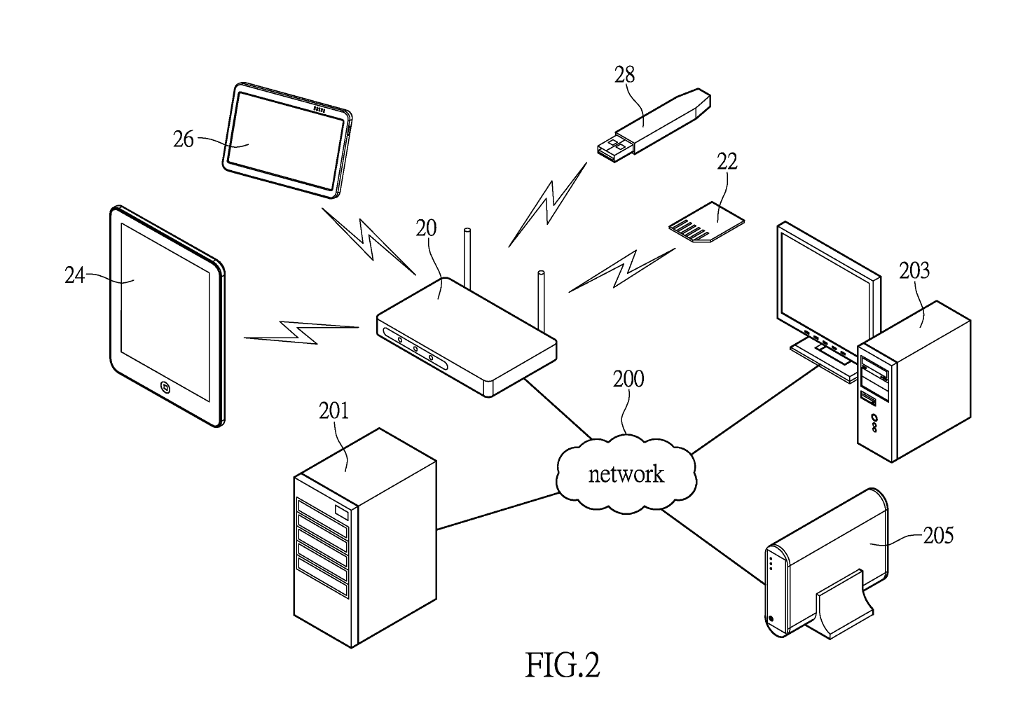

FIG. 2 shows a schematic diagram depicting relationship between the wireless storage device and the external devices.

The wireless storage device 20 accepts connection requests from a plurality of wireless terminal devices (24, 26) simultaneously while it performs data routing. The wireless terminal device (24, 26) is such as smart mobile phone, tablet computer capable of network communication, or a laptop computer.

The wireless storage device 20 may be the destination device at network 200 where the wireless terminal device (24, 26) transfers data packets. The wireless storage device 20 may also be a buffer space for data transmission between the two devices. To be a router, the terminal device connects a server 201 over the network 200 via this wireless storage device 20, especially allowed to access the network storage 205.

The wireless storage device 20 in accordance with the present invention preferably includes a slot or any card reader pluggable to a memory card 22, or an interface for a flash drive 28 or any external storage medium. Inside the device 20, a standard bus may be incorporated to be coupled with the memory card 22, the flash drive 28, or the external storage medium. The expandable mechanism allows the wireless terminal devices (24, 26) to access the memory card 22 or the storage medium through this wireless storage device 20. The wireless storage device 20 is able to perform data backup among the mentioned various storage medium. The mentioned standard bus inside the device 20 is such as USB, I2C, or Universal Asynchronous Receiver/Transmitter (UART). By the standard bus, these storage medium or interface may be inter-communicated over serial or parallel transmission scheme.

In an exemplary embodiment, the communication protocol supported by this wireless storage device 20 is such made by a Hypertext Transmission Protocol (HTTP) through a HTTP file server, a File Transfer Protocol (FTP) through a FTP file server, Samba system, or Digital Living Network Alliance (DLNA). The HTTP file server provides a data transmission service for the memory. The FTP file server is provided for the external device to access the file folders. The Samba system is freeware particularly served to bridge UNIX operating system and SMB/CIFS (Server Message Block/Common Internet File System) in Microsoft Windows operating system. DLNA-certified product serves interconnection with the digital media over wired or wireless network, especially renders a communication interface and a platform for Digital Home concept. Further, the related file system may be, but not limited to, one selected from FAT, FAT32, NTFS, and exFAT which are suitable for a variety of operating platforms.

The every wireless terminal device (24 or 26) may be connected with the wireless storage device 20 over one of the mentioned wireless communication protocols. The files in the built-in or external storage medium may be accessible to the wireless terminal device (24 or 26) via the standard bus inside the wireless storage device. Further, a specific APP may be installed in the wireless terminal device (24 or 26), and used to access the wireless storage device 20. When the user manipulates a user interface (UI) initiated by the APP, the APP assists the terminal device to establish connection with the wireless storage device 20 and access any associated storage medium. Still further, the user interface allows the user to launch a backup instruction among the storage medium.

In one further embodiment, the APP in the wireless terminal device (24, 26) also provides instruction for linking the network 200 through the wireless storage device 20 when device 20 operates as a router. The APP also achieves bidirectional data transmission with the wireless storage device 20. Further, the wireless storage device 20 may operate as a device which transfers video signals. The user interface may show the interfaces corresponding to the various functions activated by the wireless storage device 20. For example, the user interface may show an operating state indicative of the device 20 being electrically charged, a state indicative of the connected wireless terminal device being charged by the device 20. Other operating conditions such as progress of data access, storage space of storage medium, and playback of audio/video may also be shown on the user interface.

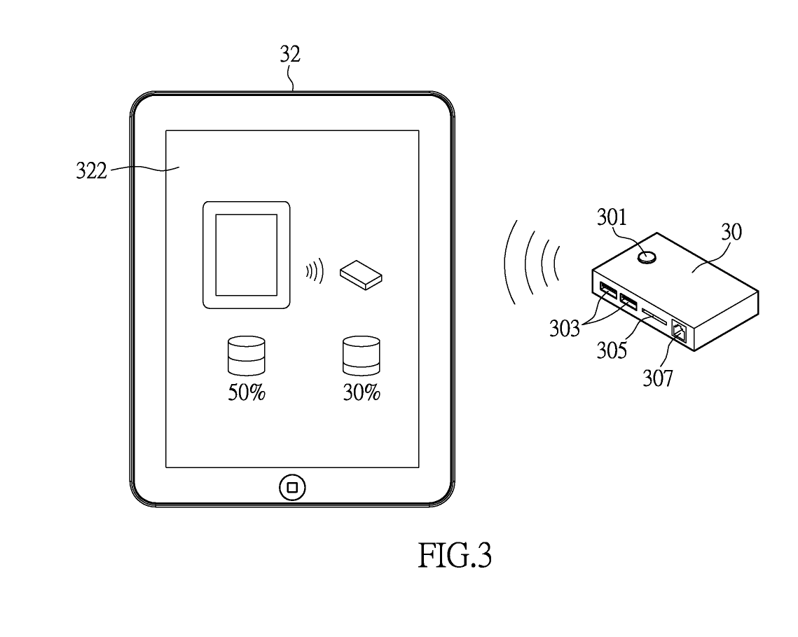

Reference is made to FIG. 3 schematically depicting a connection relationship between a wireless storage device with capability of autonomous backup and a wireless terminal device. The figure appears a wireless storage system which is formed of interconnected wireless terminal device 32 and wireless storage device 30. The processor in the wireless terminal device 32 may render a control signal for activating an autonomous backup process with the wireless storage device 30. The autonomous backup process is performed to backup or copy data among the any two storage medium selected from a memory card, a flash drive and hard disk. It is noted that the wireless terminal device 32 may simultaneously provide time stamp information to the wireless storage device 30 while conveying the control signal. Therefore, in the wireless terminal device 32, the user may easily receive the file(s) from the time-based backup file folder named according to the previously-received time stamp information. In the backup procedure, the wireless terminal device 32 may be allowed to look up the real-time percentage specified to the backup process in the wireless storage device 30 through a software program. Alternatively, the wireless storage device 30 may actively respond the backup percentage to the wireless terminal device 32 via the similar scheme.

In an exemplary embodiment, the wireless storage device 30 allows the external device to access its built-in or external storage device. As the figure shows, the device 30 may be mounted with an external connecting port 303 such as USB port allowing to be connected with the USB compatible storage device. The wireless storage device 30 may be installed with a card reader 305 which receives the memory card accessible to the wireless terminal device 32. These external connecting schemes may be provided for the various external storage medium to process the backup there-between in addition to providing the wireless terminal device 32 to access the many external storage devices. It is noted that the external storage medium such as a memory card or a flash drive is allowed to process file synchronization with the storage medium in the wireless storage device 30.

The wireless storage device 30 is made to be as a wired network router since it is installed with a network connecting port 307 such as RJ-45. The network connecting port 307 is provided to establish connection with a network or any network device. The router renders a scheme for the wireless terminal device 32 to connect with the network, for example Internet.

In particular, since the different storage medium is required to synchronize with each other, such as the data in the memory card being synchronized with the built-in memory of the wireless storage device 30, the software program executed in the wireless terminal device 32 is configured to generate a backup instruction. The backup instruction is instructed for the processor in the wireless storage device 30 to autonomously perform the backup. In one exemplary embodiment, a buffer memory is prepared for buffering data of the memory card, and then transferred to the built-in memory. However, the described backup process may not occupy any non-necessary network resource such as the bandwidth between the wireless terminal device 32 and the wireless storage device 30 because the backup process may not require any processor time of the wireless terminal device 32 but the device 30 itself conducts the data stream. Therefore, the wireless terminal device 32 may simultaneously handle other tasks when the backup process is performed in the wireless storage device 30. The other task is such as the data routing made via the wireless storage device 30 for connecting to the external network.

In an exemplary embodiment of the present invention, the shown wireless storage device 30 may be installed with a button 301, which allows a user to conveniently press the button 301 so as to launch a specific process automatically. In one example, the button 301 is activated to launch an instruction for automatically synchronizing data in the memory card plugged to the wireless storage device 30 or in the external storage device with the wireless storage device 30. The processing procedure inside the storage device 30 will take over the backup process without any non-necessary waste of external resource. Further, the button 301 may also activate a bi-directional backup process between the wireless terminal device 32 and the wireless storage device 30. One major objective of the configuration of the button 301 is to activate the process to synchronize data between at least two devices. In one further embodiment, the process made by the button 301 may be configured to, for example, activate the communication unit in the wireless storage device 30 for automatically establishing the connection with the external device such as the shown wireless terminal device 32. One more embodiment depicts the button 301 provided for initiating an access procedure between two devices, for example to launch a video broadcast.

According to one of the embodiments of the present invention, the software program installed in the wireless terminal device 32 is initiated to generate an application interface 322 onto the screen of device 32. For example depicted in the diagram, the application interface 322 is rendered as a user interface to schematically describe the process of file backup and ratio of available storage of the devices 30, 32. For describing the status of autonomous backup between two different storage medium inside the wireless storage device 30, the application interface 322 may schematically depict the progress of backup. The progress of backup may be presented by percentage or their data amount. The application interface 322 may also prompt the result of the backup process to the user. However, it is noted that, the appearance of application interface 322 may not be limited to the shown diagrams.

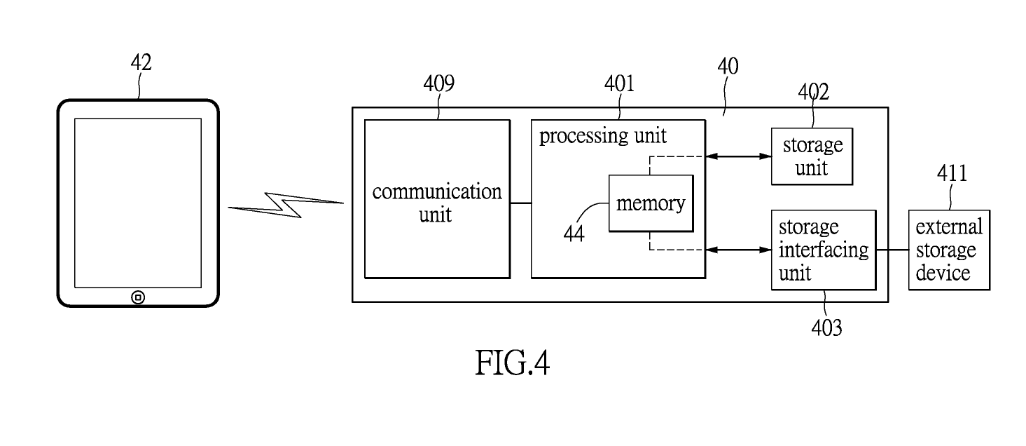

Reference is made to FIG. 4 schematically depicting the autonomous backup process performed by the wireless storage device.

A shown wireless terminal device 42 is such as a smart phone, a tablet computer, or any portable device that is able to install the software. The wireless terminal device 42 may at least be configured to have a communication circuit (not shown) intended to link the network, especially to connect with a wireless storage device 40. A communication unit 409 of the wireless storage device 40 conducts a wireless communication protocol compatible with the device 42. The communication unit 409 is then communicated with the processor of the wireless terminal device 42. The processor is used to generate an autonomous backup control signal. The control signal is then transferred to the wireless storage device 40. In addition to the memory (not shown) of the wireless terminal device 42 stores an operating system, the program instructions for performing the autonomous backup process may also be stored in the memory.

In an exemplary embodiment, a program such as APP installed in the wireless terminal device 42, the program is initiated to establish a local connection with the wireless storage device 40. The program is initiated to allow accessing the wireless storage device 40, including launching the backup process. In one further embodiment, the program is used to generate the autonomous backup control signal that instruct the wireless storage device 40 to perform the autonomous backup process between the different storage medium within the wireless storage device 40.

It is noted that, the connection between the wireless storage device 40 and the wireless terminal device 42 may be suspended when the wireless terminal device 42 has issued the autonomous backup control signal. Therefore, the wireless terminal device 42 may continue other tasks in the meantime. For example, the wireless terminal device 42 may still access the data stored in the wireless storage device 40 when the backup process is performed inside the wireless storage device 40. Alternatively, the wireless storage device 40 may still serve the routing function for the terminal device 42 to get on the network without any influence made by the background backup process. It is also noted that the processing unit 401 of the wireless storage device 40 may autonomously process the different backup processes made by the different storage medium, for example the first and second storage medium. The data exchanged in the backup processes performed in the wireless storage device 40 may be independent from the wireless terminal device 42. Therefore, the any backup process may not influence any wireless signaling bandwidth with the external device. The mentioned different storage medium includes a first storage medium that may be the medium built in the wireless storage device 40; a second storage medium is such as an external storage device coupled with the wireless storage device 40 via an interface.

While the processing unit 401 of the wireless storage device 40 performs the autonomous backup process, the inside memory or any connected memory 44 operates as a buffer memory for buffering the exchanged data.

For example, the external storage device 411 may be a memory card, which is regarded as the second storage medium. The memory card is connected to the wireless storage device 40 through a storage interfacing unit 403. A storage unit 402 regarded as the second storage medium is built in the wireless storage device 40. While the device 40 receives an instruction of autonomous backup from the wireless terminal device 42, the backup process is initiated to transfer the data in the external storage device 411 to the storage unit 402. It is noted that the various storage medium may be electrically connected with the processing unit 401. The processing unit 401 performs the autonomous backup process. The processing unit 401 may be configured to have a buffer memory 44 used in the process of autonomous backup. Therefore the backup process may not require any resource in the wireless terminal device 42. The data stream inside the storage device 40 may not affect the data bandwidth there-between. The wireless terminal device 42 therefore is able to process other tasks other than the backup.

The mentioned autonomous backup process may be activated by the wireless terminal device 42. The backup process may also be triggered by an activation interface installed in the wireless storage device 40.

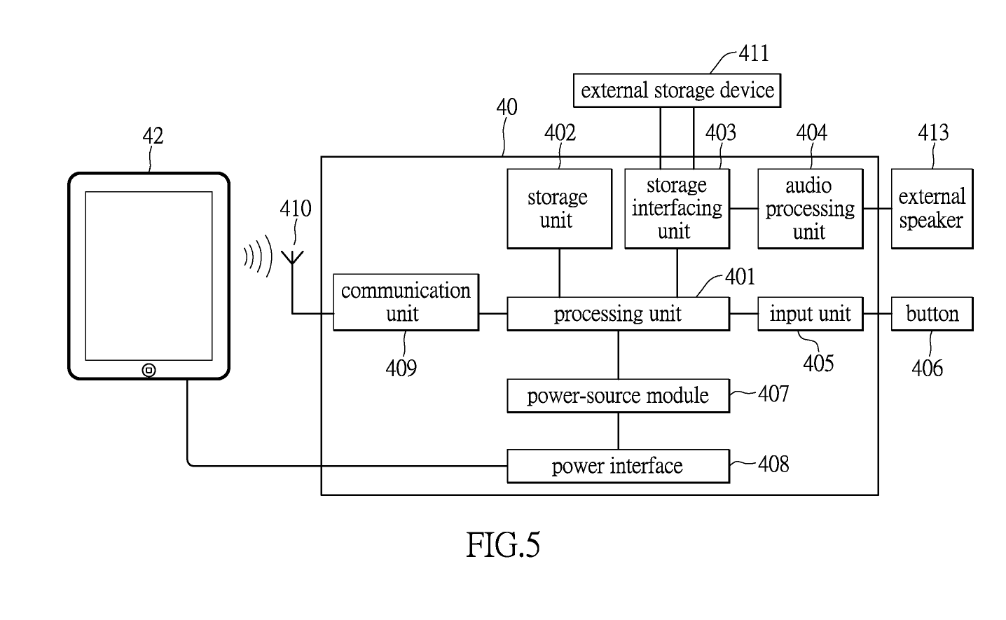

Further, the wireless storage device may be a multifunctional storage device. Reference is made to FIG. 5. The major circuits of the wireless storage device may be presented as the functional blocks shown in FIG. 5.

The figure functionally shows the core circuits of the wireless storage device 40. The core circuits include a processing unit 401 that conducts signals in the storage device and the other units electrically connected with the processing unit 401.

The wireless storage device 40 is such as a portable and standalone device. In the device, a power-source module 407 is included to manage power supplied to the wireless storage device 40. The wireless storage device 40 is not only installed with a chargeable battery set, but also operated with external electric power. Further, according to one embodiment, the wireless storage device 40 may also be a mobile power supply device, that means the storage device 40 may be used to electrically power the wireless terminal device 42 since they are connected via a charging port of the wireless terminal device 42 and a power interface 408 of the wireless storage device 40. The wireless storage device 40 may also charge the battery set of the wireless terminal device 42. The power interface 408 may be implemented as USB which is able to carry electric signals.

A communication unit 409 of the wireless storage device 40 may be in compliance with a specific wireless communication protocol. The communication unit 409 conducts communication with the wireless terminal device 42. The communication unit 409 radiates radio waves through an antenna 410. While the wireless terminal device 42 firstly scans the nearby devices by radiating the radio waves, it acquires a channel to establish the connection with the wireless storage device 40. The connection may be successfully established since it passes a specific authentication, security certificate or any specific handshaking process.

The wireless storage device 40 may have a built-in storage unit 402, for example a hard disk or solid-state disk (SSD). The storage unit 402 is provided as a storage medium for the external device. In the present example, wireless storage device 40 renders a file space for the wireless terminal device 42. The external storage device 411 connected with the wireless storage device 40 via the storage interfacing unit 403 may also be an accessible space for the wireless terminal device 42. The storage interfacing unit 403 may be the mentioned USB, a slot for plugging the memory card, or any card-reading mechanics.

In one embodiment of the present invention, the wireless storage device 40 has an input unit 405 electrically connected with the processing unit 401. The input unit 405 is provided for a user to enable an input interface to generate input signals. For example, the wireless storage device 40 is configured to have an input interface such as the shown button 406. When the user presses the button 406, a triggering signal is generated. The processing unit 401 may receive this triggering signal and execute a corresponding task, for example automatically initiating a backup process to transfer the data in a plugged memory card, or an USB-based external storage device to the built-in memory of the wireless storage device 40. The button 406 may implement a one-touch backup scheme for this system. In one further embodiment, a bi-directional synchronization may also be performed based on the connection between the wireless storage device 40 and the wireless terminal device 42. The present invention is provided as one solution of automatic backup, in-device autonomous backup, bi-directional transmission for the various wireless terminal devices (42).

The wireless storage device 40, in accordance with one embodiment of the present invention, is able to process audio/video signals. More specifically, the storage device 40 is able to process the audio or video stream from the wireless terminal device 42. The wireless storage device 40 may include an audio processing unit 404, which is used to process the audio signals generated by the wireless terminal device 42. The audio processing unit 404 is also charge of playing the audio signals. When the wireless terminal device 42, connected with the wireless storage device 40, plays audio signals, the processing unit 401 of the storage device 40 may acknowledge the playback signal. The audio processing unit 404 of the wireless storage device 40 may firstly decompress and/or decode the signals according to the acquired format. The audio may then be played via the audio processing unit 404 with a loudspeaker. The loudspeaker may be built in the wireless storage device 40, or just an external speaker 413. The audio may be downloaded by a streaming technology.

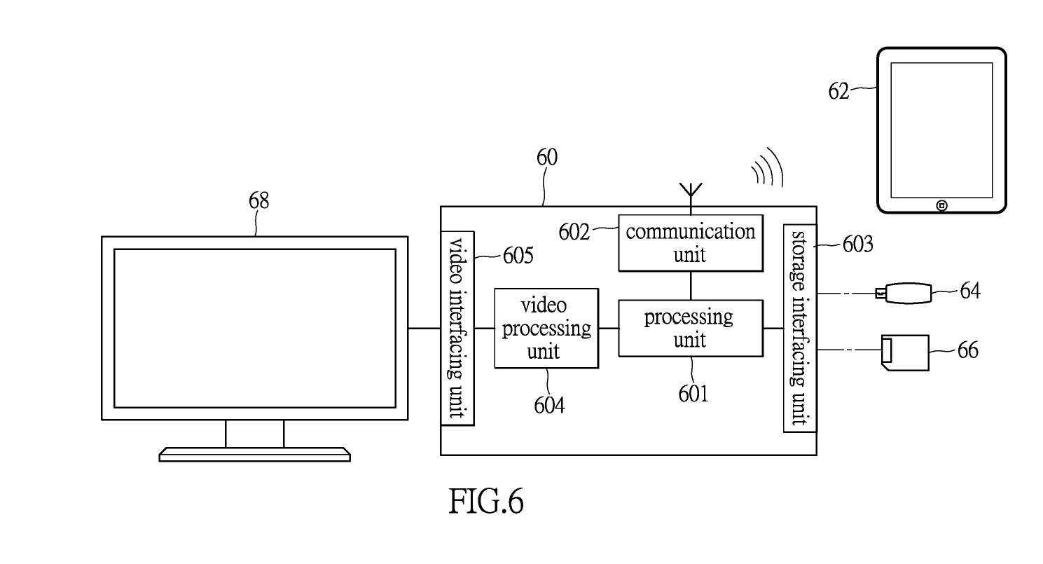

The wireless storage device may broadcast the video from its connected wireless terminal device by a streaming technology according to one embodiment of the present invention. The streaming video may be displayed on a display that is connected with this storage device. FIG. 6 schematically shows the wireless storage device broadcasting the video.

In the diagram, a wireless storage device 60 is shown to have a circuit for processing the video signals in accordance with one of the embodiments besides the major circuits shown in FIG. 5. Thus a video processing unit 604 electrically connected with the processing unit 601 is shown. The video processing unit 604 is the major circuit for processing the video signals, including performing video decoding/encoding, decompressing/compressing, or the like. The video processing unit 604 may generate the data based on the video formats supported by a video interfacing unit 605, so as to broadcast the corresponding video. For example, an external display 68 is prepared when it is connected with the wireless storage device 60 over a cable. The video interfacing unit 605 is such as a High-Definition Multimedia Interface (HDMI), audio-video interleave (AVI), or a component video connector.

The wireless terminal device 62 may connect with the wireless storage device 60 over a wireless communication. The communication unit 602 of the wireless storage device 60 is used to receive the video data from the wireless terminal device 62. The processing unit 601 then activates the video processing unit 604 to process the video signals, and broadcasts the video according to its supported video formats via the video interfacing unit 605 onto the display 68.

The source of the video signals may be the flash drive 64 or memory card 66 via the storage interfacing unit 603. While the video processing unit 604 processes the signals, the video is played onto the display 68 via the video interfacing unit 605.

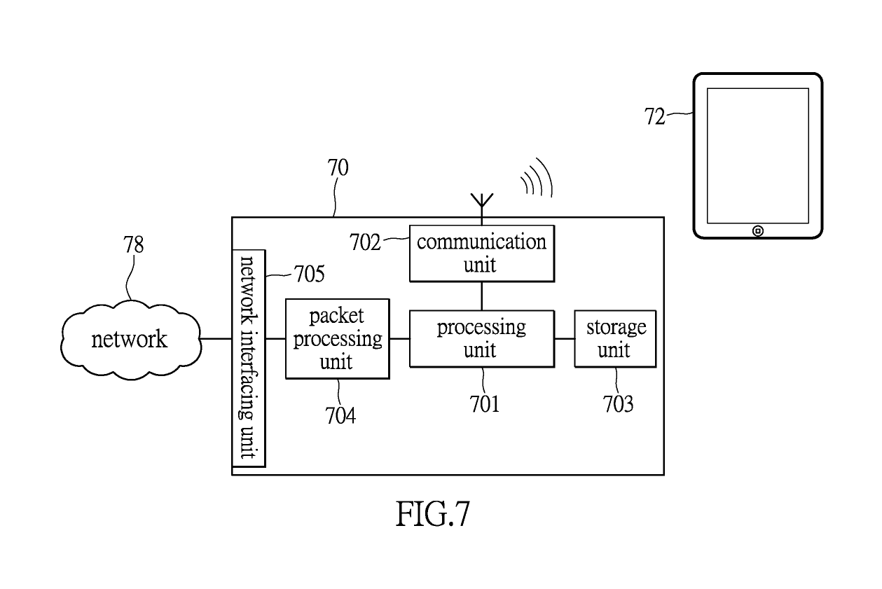

Regarding network packet routing made by the wireless storage device, reference is made to FIG. 7.

Since the wireless storage device 70 is as a routing device for the wireless terminal device 72 to bridge the network 78, some necessary circuits such as the processing unit 701 and its connected communication unit 702, storage unit 703, packet processing unit 704 and a network interfacing unit 705, are installed.

In addition to the wireless terminal device 72 allowed to access the built-in storage unit 703 of the wireless storage device 70 or its external storage device, the wireless storage device 70 also renders forwarding data packets as one solution the router generally does. The packet processing unit 704 of the device 70 is used to resolve the data packets exchanged between the wireless terminal device 72 and the network 78. The network interfacing unit 78 is such as a RJ-45-standard network connecting port.

In summation of the above description, the wireless storage device capable of autonomous backup in the disclosure is configured to perform the backup process among the various storage medium without wasting non-necessary resource. The backup procedure may not occupy the network bandwidth made by the storage device to the terminal device. Therefore, the devices connected with the wireless storage device may still operate the services such as data accessing, network routing, and/or audio/video playback during the process of backup procedure.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A wireless storage device with capability of autonomous backup, comprising:
a first storage medium;
a second storage medium;
a communication unit, used to connect with a wireless terminal device, and receive a control signal there-from; and
a processing unit, used to process the control signal in order to perform autonomous backup between the first storage medium and the second storage medium, electrically connect with the communication unit, the first storage medium, and the second storage medium.

2. The storage device according to claim 1, wherein the first storage medium is a storage device built in the wireless storage device.

3. The storage device according to claim 2, wherein the second storage medium is an external storage device connected to the wireless storage device via a storage interfacing unit.

4. The storage device according to claim 3, wherein the processing unit includes a buffer memory required in process of the autonomous backup.

5. The storage device according to claim 1, wherein the wireless storage device includes a button for performing the autonomous backup or other type of an activation interface.

6. The storage device according to claim 1, further comprising:
a power-source module, electrically connected with the processing unit, used to perform power management to the wireless storage device; and
a power interface electrically connected with the power-source module, wherein, through the power interface, the wireless storage device is electrically connected with the wireless terminal device and to power the wireless terminal device.

7. The storage device according to claim 6, further comprising:
an audio processing unit, electrically connected with the processing unit, used to process and play audio signals generated by the wireless terminal device; and
a video processing unit and a video interfacing unit, electrically connected with the processing unit, used to process video signals generated by the wireless terminal device, and play the video signals onto a display through the video interfacing unit.

8. The storage device according to claim 7, further comprising:
a packet processing unit, electrically connected to the processing unit, used to process packet routing.

9. A wireless storage system with capability of autonomous backup, comprising:
a wireless terminal device, including a communication circuit configured to connect a network, a memory storing programs instructed for performing autonomous backup, and a processor used for generating a control signal for operating an autonomous backup process;
a wireless storage device, comprising:
a first storage medium;
a second storage medium;
a communication unit, used to connect with the wireless terminal device and to generate the control signal; and
a processing unit, electrically connected with the communication unit, the first storage medium and the second storage medium, used to process the control signal for operating the autonomous backup process between the first storage medium and the second storage medium.

10. The storage system according to claim 9, wherein the first storage medium is storage medium built in the wireless storage device.

11. The storage system according to claim 10, wherein the second storage medium is an external storage device connected with the wireless storage device via a storage interfacing unit.

12. The storage system according to claim 11, wherein the wireless storage device further comprises a button or other type of activation interface activated to perform the autonomous backup process.

13. The storage system according to claim 9, wherein the wireless storage device further comprises:
a power-source module, electrically connected with the processing unit, used to manage power supplied to the wireless storage device; and
a power interface electrically connected with the power-source module, by which the power interface the wireless storage device supplies power to the wireless terminal device.

14. The storage system according to claim 13, wherein the wireless storage device further comprises:
an audio processing unit used to process audio signals generated from the wireless terminal device, and to play the audio signals; and
a video processing unit and a video interfacing unit, which is used to process video signals generated by the wireless terminal device, and play the video onto a display via the video interfacing unit.

15. The storage system according to claim 14, wherein the wireless storage device further comprises:
a packet processing unit, electrically connected with the processing unit, used to operate network routing.
